(19) United States
(12) Patent Application Publication
(10) Pub. No.: US 2006/0235584 A1
(43) Pub. Date: Oct. 19, 2006

(54) Decentralized maneuver control in heterogeneous autonomous vehicle networks

(75) Inventors: Kingsley O.C. Fregene, Andover, MN (US); Francesco Borelli, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/107,104

(22) Filed: Apr. 14, 2005

(51) Int. Cl. G05D 1/00; G01C 22/00

(52) U.S. Cl. 701/23

(57) ABSTRACT

A method for controlling the maneuvering of an autonomous vehicle in a network having a plurality of autonomous vehicles is provided. The method comprises monitoring the state of the autonomous vehicle. The method also comprises periodically receiving data on the states of a subset of the plurality of autonomous vehicles and periodically determining at least one command to a control loop for the autonomous vehicle based on the monitored state and the data from the subset of the plurality of autonomous vehicles.

### BACKGROUND

Interest in the formation control of autonomous vehicles has grown significantly over the last years. The main motivation for the increased interest is the wide range of military and civilian applications where formations of Unmanned Air Vehicles (UAV) could provide a low cost and efficient alternative to existing technology. Such applications include Synthetic Aperture Radar (SAR) interferometry, surveillance, damage assessment, reconnaissance, and chemical or biological agent monitoring. One area of current research is the development of control systems and techniques to enable large and tight formations of autonomous vehicles.

Maintaining a formation of vehicles in flight, or otherwise, is essentially a large control problem. In this control problem, the objective is to drive the vehicles along trajectories that maintain specific relative positions as well as safe distances between each pair of vehicles. Many researches have attempted to use optimal control problem formulation to tackle the problem of maintaining relative positions as well as safe distances between each pair of vehicles. In the optimal control framework, formation control is formulated as a minimization of the error between relative distances of vehicles and desired displacements. Collision avoidance requirements are optionally included as additional constraints between each pair of vehicles in the optimal control problem.

Unfortunately, the use of the optimal control problem approach can be hampered by the complexity of the calculations involved in controlling the vehicles. Further, the optimal control approach traditionally requires specialized knowledge, substantial off-line analysis, and extensive in-flight validation (often accompanied by numerous iterations of large and complex pre-specified linearized local models). As the number of vehicles increase, the solution of the associated big, non-convex optimization problems becomes prohibitive. Also, as the vehicles encounter obstacles, changes to all of the vehicles' trajectories may be required. Therefore, a need exists for a simplified technique for controlling formations of autonomous vehicles.

### SUMMARY

In one embodiment a method for controlling the maneuvering of an autonomous vehicle in a network having a plurality of autonomous vehicles is provided. The method comprises monitoring the state of the autonomous vehicle. The method also comprises periodically receiving data on the states of a subset of the plurality of autonomous vehicles and periodically determining at least one command to a control loop for the autonomous vehicle based on the monitored state and the data from the subset of the plurality of autonomous vehicles.

### DRAWINGS

The present invention can be more easily understood and further advantages and uses thereof more readily apparent, when considered in view of the description of the embodiments and the following figures in which:

FIG. 1 is one embodiment of network of autonomous vehicles each having a decentralized control system.

FIG. 2 is one embodiment of the guidance and control loops of FIG. 1.

FIG. 3 is one embodiment of the vehicle model of FIG. 2.

FIG. 4 is a perspective view of one embodiment of an autonomous vehicle with a decentralized control system for use in a network of autonomous vehicles.

FIG. 5 is an exploded view of the vehicle of FIG. 4.

In accordance with common practice, the various described features are not drawn to scale but are drawn to emphasize specific features relevant to the embodiments of the present invention. Reference characters denote like elements throughout Figures and text.

### DETAILED DESCRIPTION

In the following detailed description of the embodiments, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide improvements in the design and operation of controllers that enable maneuvering of vehicles, and in particular unmanned vehicles, in a network. In one embodiment, the controller is “decentralized” in that an autonomous controller is provided in each vehicle. The controller, in this embodiment, makes control decisions based on a limited set of data, e.g., based on monitoring the state of its own operation and the states of a subset of the other vehicles in the formation or network. In this manner, the controller is simplified because it handles problems smaller in nature than it would in a centralized framework. In one embodiment, the control problem is decomposed in a hierarchical manner to include a lower level using guidance and control loops, and, a higher level that uses a decentralized optimization-based framework with a Receding Horizon Control (RHC) scheme that models each vehicle as a multi-input, multi-output (MIMO) linear system with constraints.

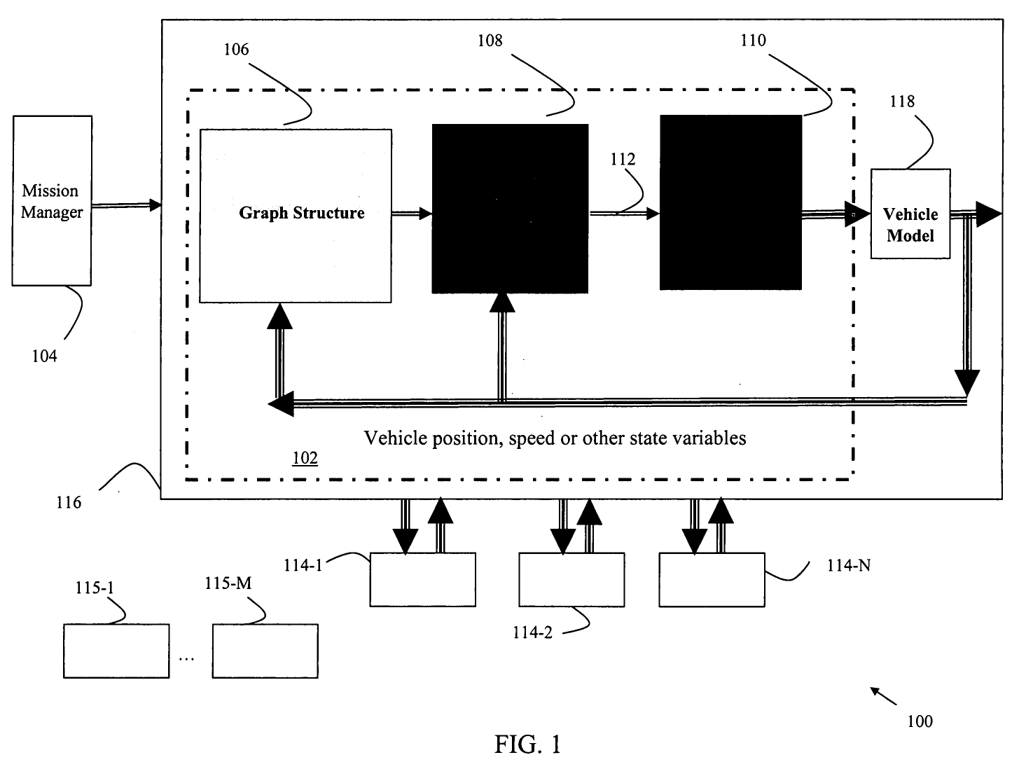

FIG. 1 is one embodiment of a vehicle network shown generally at 100. Network 100 includes a plurality of autonomous vehicles including vehicle 116, neighboring vehicles 114-1 to 114-N, and non-neighboring vehicles 115-1 to 115-M. Each vehicle includes a decentralized controller that controls its movements. The control system 102 of vehicle 116 is shown by way of example. It is understood that the other vehicles also include similar control systems.

In one embodiment, vehicles 116, 114-1 to 114-N and 115-1 to 115-N are Unmanned Air Vehicles (UAVs). In one embodiment, these vehicles are Micro Air Vehicles (MAVs). Due to its particular relevance to the emerging field of unmanned aircraft, embodiments of the present invention will be described herein largely with reference to the exemplary applications of UAVs. It will be understood, however, that embodiments of the invention are equally suited to other vehicular applications such as other flight vehicles, seagoing vessels, and road and rail vehicles, for example and non-vehicle applications where multiple spatially distributed entities are required to interact in a cooperative manner to accomplish some common objective.

Control system 102 is located within vehicle 116 and controls the vehicle 116 so that the vehicle 116 reaches a desired position. In one embodiment, control system 102 comprises an optimization based controller 108. In one embodiment, optimization based controller 108 is a decentralized RHC controller. Other decentralized controllers are contemplated for optimization based controller 108, thus, decentralized RHC control is provided by way of example and not by way of limitation. The optimization based controller 108 uses a vehicle model 118 of the vehicle 116 and neighboring vehicles 114-1 through 114-N to predict the future evolution of a subset of the network 100. Based on this prediction, at each time step, t, a certain performance index is optimized under operating constraints with respect to a sequence of future input moves. One optimal move is the control action applied to the vehicle 116 at time t. At time t+1 a new optimization is solved over a shifted prediction horizon. Each optimization based controller 108 computes local control commands 112 that are sent to guidance and control loops 110 located in control system 102.

Guidance and control loops 110 translate the commands 112 from the optimization based controller 108 into control inputs for the vehicle model 118 and allow control system 102 to determine the state of the vehicle 116. The information generated by guidance and control loops 110, as well as the state of vehicle 116 as determined by vehicle model 118 is sent back to the optimization based controller 108 so that further predictions can be generated by the optimization based controller 108. The information generated by guidance and control loops 110, as well as the state of vehicle 116 as determined by vehicle model 118 is also sent to graph structure 106 in control system 102. Graph structure 106 receives information from neighboring vehicles 114-1 through 114-N and combines this information with the information received from vehicle model 118 to generate maps of the neighboring vehicles 114-1 through 114-N with respect to the location of vehicle 116. Likewise, neighboring vehicles 114-1 through 114-N receive information from vehicle 116 and other neighbors of theirs to generate their own maps.

In one embodiment, network 100 comprises a mission manager 104. Mission manager 104 sends tasks to the control system 102 of vehicle 116 and directly and indirectly to the other vehicles 114-1 to 114-N and 115-1 to 115-M in order to carry out a desired mission. Types of tasks include but are not limited to formation patterns with neighboring vehicles 114-1 through 114-N and non-neighboring vehicles 115-1 to 115-M, final destination coordinates and other tasks for the vehicles to perform.

In operation, guidance and control loops 110 generate control inputs to the vehicle model 118 which determines the state of the vehicle 116. This state information is sent to the optimization based controller 108, the graph structure 106, and neighboring vehicles 114-1 through 114-N. Graph structure 106 receives information from neighboring vehicles 114-1 through 114-N and combines this information with the information received from vehicle model 118 to generate maps of the neighboring vehicles 114-1 through 114-N with respect to the location of vehicle 116. Likewise, neighboring vehicles 114-1 through 114-N receive information from vehicle 116 to generate their own maps. Optimization based controller 108 receives the state of the vehicle 116 from vehicle model as well as the map information from graph structure 106 and generates local control commands 112 to control the vehicle 116. These local control commands 112 are carried out by the vehicle 116 and are received by the guidance and control loops 110 which change the state of the vehicle 116 information accordingly.

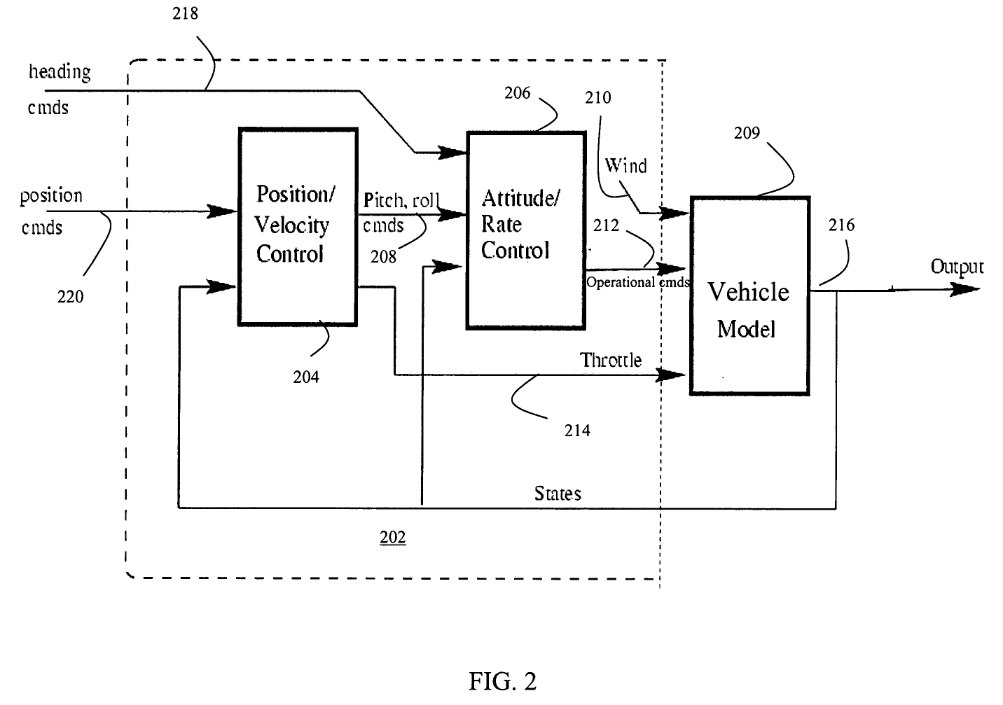

FIG. 2 is one embodiment of the guidance and control loops 110 of FIG. 1. In this embodiment, guidance and control loops 202 comprise a position/velocity control loop 204 otherwise known as “outer loop 204” and an attitude/rate control loop 206 otherwise known as “inner loop 206.” Non-linear control of the inner loop 206 and outer loop 204 is accomplished via non-linear dynamic inversion and robust multivariable control. Non-linear dynamic inversion is further described with respect to D. Enns, D. Bugajski, R. Hendrick, and G. Stein. Dynamic inversion: an evolving methodology for flight control design. International Journal of Control, 59(1):71-91, January 1994 referenced and incorporated herein. In one embodiment, vehicle model 209 is as described above with respect to vehicle model 118 of FIG. 1. Essentially, the nonlinearities of the vehicle model 209 are cancelled (to a certain degree) by inversion and a desired dynamics is imposed on the resulting system so that the behavior from the desired dynamics for each controlled variable to the actual variable resembles a set of integrators. However, this is only true when there is perfect inversion. Since perfect inversion rarely occurs in reality, the response of these state variables tend to be more like a first order transfer function than a pure integrator.

Guidance and control loops 202 receive commands from, for example, the optimization based controller 108 of FIG. 1 in the form of position commands 220 and heading commands 218. In one embodiment, heading and position commands could be replaced by specific way-points. In one embodiment, these way-points are expressed in terms of desired positions/heading and corresponding velocities/heading rate to these coordinates.

The outer loop 204 takes the position commands 220 as inputs and generates corresponding tilt (pitch, roll) 208 commands. Outer loop 204 also generates throttle commands 214. The angles of the tilt commands 208 depend on how fast the vehicle 116 is commanded to translate in a given direction. This in turn depends on the position commands 220. The tilt commands 208 and the heading commands 218 are input into the inner loop 206. The inner loop 206 outputs the actual operational commands 212 required to accomplish the commanded maneuver. The operational commands 212 are sent to the appropriate control mechanisms to physically carry out the desired operation of the flight vehicle.

Operational commands 212 as well as throttle commands 214 and wind disturbances 210 are the inputs to the vehicle model 209. The vehicle model 209 outputs state variables 216. State feedback is available to generate an error signal used in the tracking control of various state variables 216. Assuming that actuators do not hit rate or position limits for most of the flight envelope, the dynamics from the position commands 220 and heading commands 218 to the state variables 216 is that of a multivariable linear system. This is because when actuators are not limited, they provide the requisite level of effort needed to position the vehicle as desired. Accordingly, nonlinearities due to effects like saturation will not be evident and the resulting closed loop system exhibits linear behavior. This behavior is multivariable because there are multiple inputs/outputs and coupling between position variables may be present due to non-perfect dynamic inversion and/or the physics of the vehicle itself.

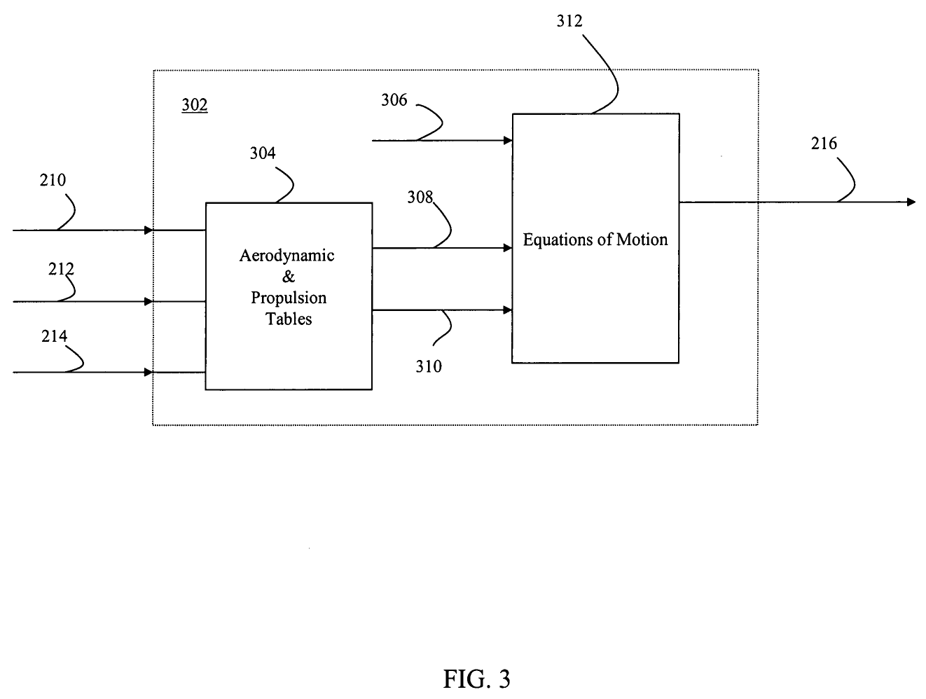

FIG. 3 is one embodiment of vehicle model 209 of FIG. 2. Models 118, 209 and 302 are empirical representations of the vehicle 116 that enable the determination of various states of the vehicle 116 based on commands provided to the vehicles operation systems. In this embodiment, model 302 comprises aerodynamic and propulsion tables 304. Aerodynamic and propulsion tables 304 are typically obtained from wind tunnel experiments. The tables 304 receive as inputs operational commands 212 from inner loop 206, throttle commands 214 from outer loop 204 and wind disturbances 210. The table entries are interpolated to recover forces 308 and moments 310 which act as input to the basic equations of motion 312 that describe the state evolution of the vehicle 116. Measured states 306 are used to compute Direction Cosine Matrix (DCM) elements. The measured states 306 represent the current states of the vehicle 116. This is input into the equations of motion 312 and combined with the forces 308 and moments 310 to generate the next state variables 216. In one embodiment, there are thirteen states represented as:

x₁=p; where x₁ is the roll rate angular velocity component

x₂=q; where x₂ is the pitch angular velocity component

x₃=r; where X₃ is the spin angular velocity component

x₄=u; where x₄ is the translational velocity component measuring forward movement

x₅=v; where x₅ is the translational velocity component measuring sideways movement

x₆=w; where x₆ is the translational velocity component measuring up and down movement

x₇=N; where x₇ is the difference between current position and the starting position in the North direction

x₈=E; where x₈ is the difference between current position and the starting position in the East direction

x₉=h; where x₉ is the distance from the ground

x₁₀=e₀

x₁₁=e₁

x₁₂=e₂

x₁₃=e₃; where x₁₀−x₁₃ are the quaternions for orientation.

### Illustrative Embodiment

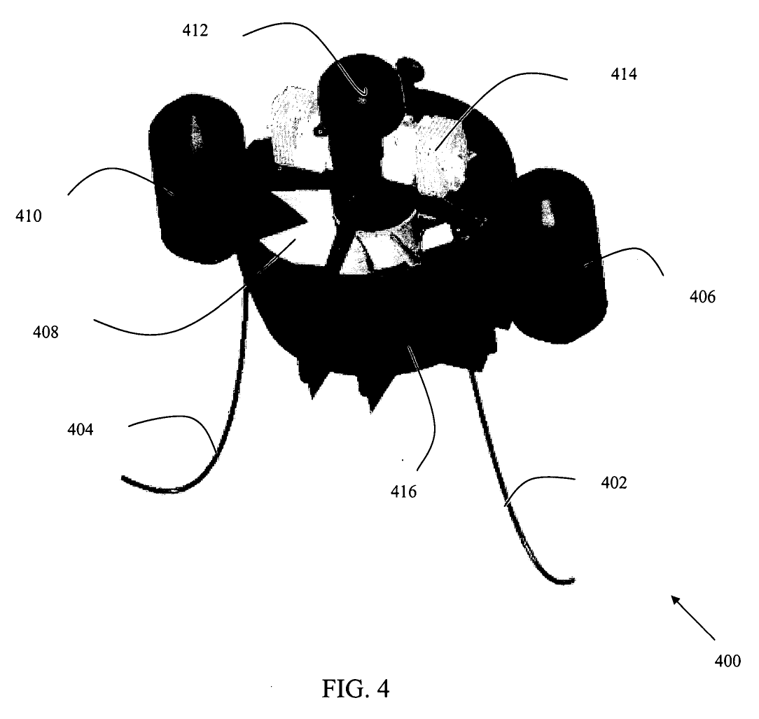

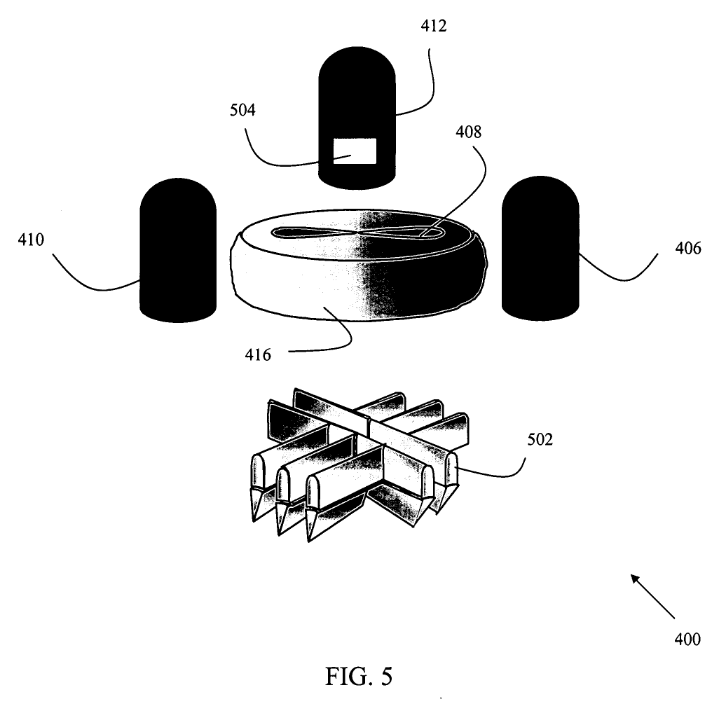

FIG. 4 is a perspective view and FIG. 5 is an exploded view of one embodiment of an autonomous vehicle, indicated generally at 400, that uses a decentralized controller to control the maneuvering of the vehicle in a network of vehicles. In this illustrative embodiment, vehicle 400 is an Unmanned Air Vehicle (UAV) that comprises a body 416. Body 416 comprises support structures 402 and 404 (third support structure not visible) that are adapted to contact the ground and keep body 416 at an elevated distance from the ground. Body 416 also comprises first pylon 410 and second pylon 406. First pylon 410 and second pylon 406 house sensors and payloads (not visible). Body 416 comprises a main pylon 412 that is adapted to support a motor 414. Main pylon 412 is also adapted to mate with a propeller 408. Main pylon 412 contains a control system 504. In one embodiment, control system 504 is as described with respect to control system 102 of FIG. 1. Control system 504 may be implemented in digital electronic circuitry, or with a programmable processor (for example, a special-purpose processor or a general-purpose processor such as a computer) firmware, software, or in combinations of them. Motor 414 powers propeller 408 which rotates independently of the main pylon 412 causing a stream of air (propeller wash) towards vanes 502. Vanes 502 are adapted to deflect and based on the deflection of vanes 502 the rotation, pitch and tilt of vehicle 400 is controlled. Vanes 502 and propeller 408 are embodiments of maneuvering systems. Other types of maneuvering systems include but are not limited to rudders, wheels, and other types of systems used to maneuver a vehicle.

An example of using vehicle 400 in network 100 of FIG. 1 will now be described. It is understood that this illustrative embodiment is provided by way of example and not by way of limitation. In this example, vehicle 400 is modeled as a constrained linear MIMO model of second order for each axis, where the inputs to the systems are accelerations along the N, E, h axis and the states of the systems are speeds and positions along the N, E, h axis. The dynamics of vehicle 400 is described using the following linear discrete-time model:
xₖ₊₁=ƒ(xₖ,uₖ) (1)
where the state update function ƒ:R⁶×R³→R⁶ is a linear function of its inputs and xₖεR⁶ and uₖεR³ are states and inputs of the vehicle 400 at time k, respectively. In particular,

$${x}_{k} = [ \begin{matrix}{x}_{k , pos} \\ {x}_{k , vel}\end{matrix} ] , u = [ \begin{matrix}N \text{-} axis acceleration \\ E \text{-} axis acceleration \\ h \text{-} axis acceleration\end{matrix} ]$$

and x_{k,pos}εR³ is the vector of N, E, h coordinates and x_{k,vel}εR³ is the vector of N-axis, E-axis and h-axis velocity components at time k. Speed and acceleration constraints of the vehicle 400 are represented as follows:
xᵥₑₗεXᵥ={zεR³|−10/ƒt/s≦zᵢ≦10/ƒt/s,i=1,2,3}
uεXᵤ={zεR³|−3/ƒt/s²≦zᵢ≦3/ƒt/s²,i=1,2,3} (2)

Even if at the lower level the acceleration cannot be directly commanded, model (1) has two key advantages. Firstly, it generates position references which take into account constraints in the acceleration and in the speed of the vehicle 400. Secondly, it allows redesign/modification of the inner loop 206 controllers in order to directly track speed or position references (that is, in fact, already partially possible on the real vehicle 400).

The objective of UAV autonomous formation flight control is therefore to provide position, speed or acceleration commands to a flock of UAVs in order to achieve certain mission objectives (which may have been decided at a higher level from a mission manager 104). A way to control formation flight is through the use of an optimization based controller 108 as described above with respect to FIG. 1 and further described below. Each optimization based controller 108 computes the local control commands 112 that are sent to control loops 110 located in control system 102. In one embodiment, local control commands 112 comprise heading commands 218 and position commands 220. Local control commands 112 are based on the vehicle state variables 216 generated by control loops 110 and vehicle model 118 and the state variables of neighboring vehicles 114-1 through 114-N. On each vehicle 400, the current state and the model of its neighboring vehicles 114-1 through 114-N are used to predict their possible trajectories so that vehicle 400 moves accordingly. This is performed by the graph structure 106 which communicates with the neighboring vehicles 114-1 through 114-N.

A set of Nᵥ UAVs (1) where the i-th UAV is described by the discrete-time time-invariant state equation:
xₖ₊₁ⁱ=ƒⁱ(xₖⁱ,uₖⁱ) (3)
where xₖⁱεRⁿ, uₖⁱεR^{m}, n=6, m=3 are states and inputs of the i-th system, respectively, and ƒⁱ is the state update function (1). The speed and acceleration of each UAV is constrained as in equation (2). The set of Nᵥ UAVs will hereinafter be referred to as a team system. This is shown by letting \overline{x}ₖεR^{N}^{ᵥ}^{×n} and \overline{u}ₖεR^{N}^{ᵥ}^{×m} be the vectors which collect the states and inputs of the team system at time k, i.e. \overline{x}ₖ=[\overline{x}ₖ¹, . . . , \overline{x}ₖ^{N}^{_{v],\overline{u}}}ₖ=[\overline{u}ₖ¹, . . . , \overline{u}ₖ^{N}^{ᵥ}], with:
\overline{x}ₖ₊₁=\overline{ƒ}(\overline{x}ₖ,\overline{u}ₖ) (4)

The equilibrium pair of the i-th system is denoted by (xₑⁱ,uₑⁱ) and (\overline{x}ₑ,\overline{u}ₑ) the corresponding equilibrium for the team system. This is essentially saying that if the vehicle is in the equilibrium state, it will stay there. So far the individual systems belonging to the team system are completely decoupled. An optimal control problem is considered for the team system where cost function and constraints couple the dynamic behavior of individual systems. In addition to being prescribed to meet the objective, the cost function is also designed to produce an efficient result. Types of efficiencies that the cost function handles include but are not limited to reducing the amount of fuel used, reducing the amount of distance traveled, and other mission requirements. In this embodiment, a graph topology is used to represent the coupling and is performed by the graph structure 106 in the following way. The i-th system is associated with the i-th node of the graph, and if an edge (i, j) connecting the i-th and j-th node is present, then the cost and the constraints of the optimal control problem will have a component, which is a function of both xⁱ and x^{j}. The graph has the ability to be either directed or undirected and the edge will be present if the nodes are close enough. Therefore, before defining the optimal control problem, the time-varying graph is defined as:
G(t)={V, A(t)} (5)
where V is the set of nodes V={1, . . . , Nᵥ} and A(t)⊂V×V the set of time-varying arcs (i, j) (lines connecting the nodes) with iεV,jεV. The time-dependence of the set of arcs is assumed to be a function of the relative distance of the vehicles. The set A(t) is defined as:
A(t)={(i,j)εV×V|∥x_{t,pos}ⁱ−x_{t,pos}ⁱ ∥≦dₘᵢₙ} (6)
that is the set of all the arcs, which connect two nodes whose distance is less than or equal to dₘᵢₙ which is defined by the user. Ranges of values for dₘᵢₙ vary and depend in part on whether vehicle 400 is within a distance in which to communicate with neighboring vehicles 114-1 through 114-N.

The states of all neighbors of the i-th system at time k, is denoted as \tilde{x}ₖⁱ, i.e.
\tilde{x}ₖⁱ={xₖ^{j}εRⁿ^{^{j}}|(j,i)εA(k)},\tilde{x}ₖⁱεR^{ñ}^{ₖ}^{ⁱ} with ñₖⁱ=Σⱼdim{nₖ^{j}|(j,i)εA(k)}
Analogously, ũₖ ⁱεR^{\tilde{m}}^{ₖ}^{ⁱ} denotes the inputs to all the neighbors of the i-th system at time k. One constraint that is used is a safety constraint. This provides protection against the vehicle 400 crashing into the neighboring vehicles 114-1 through 114-N. The safety constraint is defined as:
g^{i,j}(xₚₒₛⁱ,xₚₒₛ^{j})≦0 (7)
which is the safety distance constraints between the i-th and the j-th UAV, with g^{i,j}:R³×R³→R^{nc}^{_{i,j}} a short form of the interconnection constraints defined between the i-th system and all of its neighbors is:
gₖⁱ(xₖⁱ,\tilde{x}ₖⁱ)≦0 (8)
with gₖⁱ:Rⁿ^{ⁱ}×R^{ñ}^{ₖ}^{^{i→R}}^{nc}^{_{i,k}}. One embodiment of a cost function is defined as:

$$l ( \tilde{x} , \tilde{u} ) = {\sum }_{i = 1}^{{N}_{v}} {l}_{k}^{i} ( {x}^{i} , {u}^{i} , {\tilde{x}}_{k}^{i} , {\tilde{u}}_{k}^{i} ) \qquad ( 9 )$$

Where lⁱ:Rⁿ^{ⁱ}×R^{m}^{ⁱ}×R^{ñ}^{ₖ}^{^{l}}×R^{\tilde{m}}^{ₖ} ^{^{l}}→R is the cost associated with the i-th system and is a function of its states and the states of its neighbor states. In one embodiment, the cost function is implemented in the optimization based controller 108 and is a function of the vehicle state variables 216 generated by control loops 110 and vehicle model 118 and the neighboring vehicles 114-1 through 114-N. Assuming that L is a positive convex function with l(\overline{x}ₑ,\overline{u}ₑ)=0, the decentralized scheme is considered next.

Considering the i-th system and the following finite time optimal control problem Pᵢ(t) at time t:

$${min}_{{\tilde{U}}_{t}^{i}} {\sum }_{k = 0}^{N - 1} {l}_{t}^{i} ( {x}_{k , t}^{i} , {u}_{k , t}^{i} , {\tilde{x}}_{k , t}^{i} , {\tilde{u}}_{k , t}^{i} ) + {l}_{N}^{i} ( {x}_{N , t}^{i} , {\tilde{x}}_{N , t}^{i} ) \\ subj . to {x}_{k + 1 , t}^{i} = {f}^{i} ( {x}_{k , t}^{i} , {u}_{k , t}^{i} ) , k \geq 0 \\ {x}_{k , t , vel}^{i} ∈ {X}_{v} , {u}_{k , t}^{i} ∈ {X}_{u} , \\ k = 1 , … , N - 1 \\ {x}_{k + 1 , t}^{j} = {f}^{j} ( {x}_{k , t}^{j} , {u}_{k , t}^{j} ) , ( j , i ) ∈ A ( t ) , \\ k = 1 , … , N - 1 \\ {x}_{k , t , vel}^{i} ∈ {X}_{v} , {u}_{k , t}^{j} ∈ {X}_{u} , ( j , i ) ∈ A ( t ) , \\ k = 1 , … , N - 1 \\ {g}^{i , j} ( {x}_{k , t , pos}^{i} , {x}_{k , t , pos}^{j} ) \leq 0 , ( i , j ) ∈ A ( t ) \\ k = 1 , … , N - 1 \\ {g}^{q , r} ( {x}_{k , t , pos}^{q} , {x}_{k , t , pos}^{r} ) \leq 0 , ( q , i ) ∈ A ( t ) , ( r , i ) ∈ A ( t ) , \\ k = 1 , … , N - 1 \\ {x}_{k , t , vel}^{i} ∈ {Ξ}_{v} , k \geq 0 \\ {x}_{k , t , vel}^{j} ∈ {Ξ}_{v} , ( j , i ) ∈ A ( t ) , k \geq 0 \\ {x}_{N , t}^{i} ∈ {X}_{f}^{i} , {x}_{N , t}^{j} ∈ {X}_{f}^{j} , ( i , j ) ∈ A ( t ) \\ {x}_{0 , t}^{i} = {x}_{t}^{i} , {\tilde{x}}_{0 , t}^{i} = {\tilde{x}}_{t}^{i} \qquad ( 10 )$$

where N is the prediction horizon which is shifted to get closer to the goal, and the “subj. to” are the constraints that the cost function abides by. Also, where

$${\tilde{U}}_{t}^{i} {=}^{Δ} {[ {u}_{0 , t}^{i} , {\tilde{u}}_{0 , t}^{i} , … , {u}_{N - 1 , t}^{i} , {\tilde{u}}_{N - 1 , t}^{i} ]}^{′} ∈ {R}^{s} , s {=}^{Δ} ( {\tilde{m}}_{i} + {m}^{i} ) N$$

denotes the optimization vector, x_{k,t} ⁱ denotes the state vector of the i-th node predicted by the optimization based controller 108 at time t+k obtained by starting from the state Xₜⁱ and applying to system (1) the input sequence u_{o,t}ⁱ, . . . , u_{k-1,t}ⁱ. The tilded vectors denote the prediction vectors associated with the neighboring systems assuming a constant interconnection graph over the prediction horizon. Denote by Ũₜⁱ*=[u*_{0,t}ⁱ,ũ*_{0,t}ⁱ, . . . , u*_{N-1,t}ⁱ,ũ*_{N-1,t}ⁱ] the optimizer of problem Pᵢ(t). Problem Pᵢ(t) involves only the state and input variables of the i-th node and its neighbors at time t. The optimization based controller 108 at time t is as follows. The graph connection A(t) is computed according to equations (5) and (6) which is performed in graph structure 106. Each node i solves problem Pᵢ(t) using equation (10). Node i implements the first sample of Ũₜⁱ* to optimize the solution. Each node then repeats the previous calculations at time t+1, based on the new state information xₜ₊₁ⁱ,\tilde{x}ₜ₊₁ⁱ. In order to solve problem Pᵢ(t) each node needs to know its current states, its neighbor's current states, its terminal region, its neighbors' terminal regions and models and constraints of its neighbors. Based on such information each node computes its optimal inputs and its neighbors' optimal inputs assuming a constant set of neighbors over the horizon. The input to the neighbors will only be used to predict their trajectories and then discarded, while the first component of the i-th optimal input of problem Pᵢ(t) will be implemented on the i-th node.

What is claimed is:

1. A method for controlling the maneuvering of an autonomous vehicle in a network having a plurality of autonomous vehicles, the method comprising:
monitoring the state of the autonomous vehicle;
periodically receiving data on the states of a subset of the plurality of autonomous vehicles; and
periodically determining at least one command to a control loop for the autonomous vehicle based on the monitored state and the data from the subset of the plurality of autonomous vehicles.

2. The method of claim 1, wherein monitoring the state of the autonomous vehicle comprises monitoring at least one of position coordinates, translational velocity components, angular velocity components and angle of attitude components.

3. The method of claim 1, wherein periodically receiving data on the states of a subset of the plurality of autonomous vehicles comprises receiving data from neighboring vehicles based on a graph structure.

4. The method of claim 1, wherein periodically determining at least one command to a control loop comprises using a cost function to achieve an optimized solution.

5. A vehicle comprising:
a motor;
a maneuvering system coupled to the motor;
a control system coupled to provide inputs to the maneuvering system;
wherein the control system includes:
control loops that control the maneuvering system and whose outputs influence the evolution of the state variables of the vehicle;
a graph structure that generates a graph that represents the relative positions of the vehicles;
an optimization based controller that receives the graph from the graph structure and values of state variables resulting from the action of the control loops and receives values of state variables for a subset of neighboring vehicles in a plurality of vehicles and generates command signals for the control loops.

6. The vehicle of claim 5, wherein the vehicle is an Unmanned Air Vehicle (UAV).

7. The vehicle of claim 5, wherein the vehicle is a Micro Air Vehicle (MAV).

8. A control system for a vehicle, the vehicle having a maneuvering system, the control system comprising:
control loops that control the maneuvering system and that output control signals which influence the evolution of the state variables of the vehicle;
a graph structure that generates a graph that represents the relative positions of the vehicles;
an optimization based controller that receives the graph from the graph structure and values of state variables that result from applying the control loops and receives values of state variables for a subset of neighboring vehicles in a plurality of vehicles and generates command signals for the control loops.

9. The control system of claim 8, wherein the command signals output by the optimization based controller are at least one of heading commands and position commands.

10. The control system of claim 8, wherein the optimization based controller is a decentralized receding horizon controller.

11. A method of navigating a vehicle in a network of vehicles, the method comprising:
receiving a destination;
monitoring at least one of position and heading of the vehicle;
monitoring at least one of position and heading of at least one neighboring vehicle;
generating a graph connection between the vehicle and the neighboring vehicle that is a function of at least one of position and heading of the vehicle and at least one of position and heading of the neighboring vehicle;
generating at least one of an optimized heading and an optimized position that is a function of the graph connection between the vehicle and the neighboring vehicle and at least one of position and heading of the vehicle, wherein at least one of the optimized heading and the optimized position is optimized with respect to mission requirements;
updating at least one of the heading and position of the vehicle, wherein at least one of updated heading and updated position is a function of at least one of the optimized heading and the optimized position.

12. A machine-readable medium having instructions stored thereon for a method of navigating a vehicle in a network of vehicles, the method comprising:
receiving a destination;
monitoring at least one of position and heading of the vehicle;
monitoring at least one of position and heading of at least one neighboring vehicle;
generating a graph connection between the vehicle and the neighboring vehicle that is a function of at least one of position and heading of the vehicle and at least one of position and heading of the neighboring vehicle;
generating at least one of an optimized heading and an optimized position that is a function of the graph connection between the vehicle and the neighboring vehicle and at least one of position and heading of the vehicle, wherein at least one of the optimized heading and the optimized position is optimized with respect to mission requirements;
updating at least one of the heading and position of the vehicle, wherein the at least one of updated heading and updated position is a function of at least one of the optimized heading and the optimized position.

13. A vehicle network comprising:
a plurality of vehicles;
each vehicle comprising:
a motor;
a maneuvering system coupled to the motor;
a control system coupled to provide inputs to the maneuvering system;
wherein the control system includes:
control loops that control the maneuvering system and whose outputs influence the evolution of the state variables of the vehicle;
a graph structure that generates a graph that represents the relative positions of the vehicles;
an optimization based controller that receives the graph from the graph structure and values of state variables from the control loops and receives values of state variables for a subset of neighboring vehicles in a plurality of vehicles and generates command signals for the control loops; and
a mission manager that is adapted to provide mission objectives to the control system of the plurality of vehicles.
